(19) United States
(12) Patent Application Publication
(10) Pub. No.: US 2010/0288651 A1
(43) Pub. Date: Nov. 18, 2010

(54) MULTI-WALLED CARBON NANOTUBE SENSOR COMPRISING INTERCALATING SPECIES AND METHOD OF DETECTION

(75) Inventors: Richard Guy Compton, Oxford (GB); Craig Edward Banks, Nottingham (GB); Xiaobo Ji, Oxford (GB)

Correspondence Address: BROOKS KUSHMAN P.C., 1000 TOWN CENTER, TWENTY-SECOND FLOOR, SOUTHFIELD, MI, 48075, US

(73) Assignee: ISIS INNOVATION LIMITED, Oxford (GB)

(21) Appl. No.: 12/293,712

(22) PCT Filed: Mar. 20, 2007
(86) PCT No.: PCT/GB07/01010

§ 371 Date: Aug. 2, 2010

(30) Foreign Application Priority Data
Mar. 20, 2006 (GB) 0605557.8

(51) Int. Cl. G01N 27/26; G01N 27/30; B32B 9/00; B82B 1/00

(52) U.S. Cl. 205/780.5; 204/400; 205/794.5; 428/367; 977/752

(57) ABSTRACT

There is provided a method of detecting an analyte in a sample, which comprises the steps of contacting the sample with a working electrode in the presence of an electrolyte and determining the electrochemical response of the working electrode to the sample, wherein the working electrode comprises a multi-walled carbon nanotube (MWCNT) and wherein detection takes place in the presence of a species which is capable of forming an intercalation compound with a carbon host material. Electrochemical sensors and compositions suitable for use in said method are also provided.

### FIELD OF THE INVENTION

The present invention relates to the electrochemical detection of analytes and materials suitable for use therein.

### BACKGROUND TO THE INVENTION

Carbon has been widely used in electrochemical systems for numerous years. In many ways, carbon is an ideal electrode material, having good corrosion resistance, high electrical conductivity, low cost and a wide anodic potential window in aqueous solutions. According to the degree of graphitization, it is morphologically diverse, existing in various forms ranging from carbon black to glassy carbon, carbon fibres and pyrolytic graphite.

Typically, there are two planes in graphite electrode materials. The basal plane is an exposed hexagonal surface which is parallel to the graphite layer and has an interlayer spacing of 3.35 Å. The edge plane is the surface perpendicular to the graphite layer. Surface defects occur in the form of steps exposing the edges of the graphite layers as a basal plane. These defects typically contain mostly basal terraces separated by a few edge plane steps. Due to the nature of the chemical bonding in graphite, the edge and basal planes exhibit different electrochemical properties. For example, the edge plane exhibits considerably faster electrode kinetics for the oxidation or reduction of redox species than the basal plane. This means that, in many instances, an electrode consisting mainly of edge planes (e.g. an edge plane pyrolytic graphite electrode) will show a nearly electrochemically reversible (“Nernstian”) voltammogram, while an electrode consisting mainly of basal planes (e.g. a basal plane pyrolytic electrode) may show electrochemically irreversible behaviour for the same species which depends greatly on the amount of edge planes present.

Carbon may exist in the form of nanotubes. Carbon nanotubes (CNTs) are concentric, graphitic cylinders which may be closed at either end due to the presence of five-membered rings. There are two distinct classes of CNT: single walled (SWCNTs) and multi-wall carbon nanotubes (MWCNTs). SWCNTs comprise a single graphite sheet rolled flawlessly, typically producing a tube diameter of ca. 1 to 2 nm. MWCNTs comprise several such concentric tubes fitted one inside the other, an exemplary MWCNT being a “bamboo” MWCNT.

CNTs have been widely used in electrochemistry, especially in electroanalysis, where CNT-modified electrodes have been reported to have superior “electrocatalytic” sensing properties. It has been suggested that the edge plane-like sites or defects which occur at the ends and along the tube axis of the CNTs are often responsible for their electrocatalytic properties. In addition, it has been reported that catalysis of CNTs may also arise from the presence of metal (e.g. iron) oxide impurities present therein. These impurities are believed to act as nano-particulate centers for redox activity, which are electrically “wired” by the CNTs.

The usefulness of many carbon electrodes in non-aqueous solutions is limited by their susceptibility to intercalation. For example, it is known that propylene carbonate, when driven by appropriate applied potentials, intercalates graphite, resulting in exfoliation of the graphite layers and destruction of the graphite structure, effectively rendering the electrode useless for voltammetry (Herstedt et al, Electrochimica Acta 2004, 49, 4939; Hu et al, Electrochem. Sol. St. Lett 2004, 7, A442; and Wang et al, J. Power Sources 74, 74, 142). This is especially the case when tetra-n-butylammonium perchlorate (TBAP) is used as supporting electrolyte, in which case both the TBA⁺ and ClO₄⁻ ions may intercalate into graphite layers (Chung et al, J. Electrochem. Soc. 2000, 147, 4391; and Santhanam, J. Power Sources 1995, 56, 101). It has also been reported that ammonia co-intercalates into graphite with alkali or alkaline earth metals (Akuzawa et al, 1987).

### SUMMARY OF THE INVENTION

The present invention is based on a discovery that MWCNT electrodes are less susceptible to intercalation processes than other forms of carbon. Without wishing to be bound by theory, it is believed that the unique rigid structural morphology of MWCNTs prevents intercalation of, for example, solvent and/or supporting electrolyte. In particular, it is believed that intercalating media are prevented from penetrating between the concentric tubes and so intercalation of the carbon nanotubes is inhibited. The use of electrodes comprising MWCNTs may therefore allow excellent and quantitative voltammetric responses to be attained.

Accordingly, a first aspect of the invention is a method of detecting an analyte in a sample, which comprises the steps of contacting the sample with a working electrode in the presence of an electrolyte and determining the electrochemical response of the working electrode to the sample, wherein the working electrode comprises a MWCNT and wherein detection takes place in the presence of a species which is capable of forming an intercalation compound with a carbon host material.

A second aspect of the invention is an electrochemical sensor for the detection of an analyte in a sample, which comprises working and counter electrodes and an electrolyte, wherein the working electrode comprises a MWCNT and wherein the sensor comprises a species which is capable of forming an intercalation compound with a carbon host material.

Another aspect relates to the use of an electrode material for the electrochemical detection of an analyte in a sample, wherein the material comprises a MWCNT and wherein detection takes place in the presence of a species which is capable of forming an intercalation compound with a carbon host material.

Another aspect of is a composition comprising a MWCNT and a species which is capable of forming an intercalation compound with a carbon host material.

### BRIEF DESCRIPTION OF THE DRAWINGS

FIG. 1 shows cyclic voltammograms recorded in a propylene carbonate solution containing 0.1 M TBAP which has been bubbled with 10% vol ammonia for 45 seconds. Glassy carbon (GC), basal plane pyrolytic graphite (BPPG) and edge plane pyrolytic graphite (EPPG) electrodes were used. The dashed line indicates the response of the electrode in the absence of ammonia. The scan rate in all cases was 100 mV s⁻¹.

FIG. 2 shows successive cyclic voltammograms recorded at a basal plane pyrolytic graphite electrode in propylene carbonate containing 0.1 M TBAP. Scans were recorded at 100 mVs⁻¹.

FIG. 3 shows various cyclic voltammetric responses of MWCNT-modified GC electrodes in a propylene carbonate (PC) solution containing 0.1 M TBAP which has been bubbled with 10% vol ammonia for 45 seconds. The MWCNT-modified electrodes were exposed to the PC solution for (A) 30 minutes; (B) 24 hours; and (C) MWCNT one week. The dashed line indicates the response of the electrodes in the absence of ammonia. The scan rate was 100 mV s⁻¹.

FIG. 4 shows various X-ray diffraction (XRD) patterns of bamboo MWCNTs before and after exposure to propylene carbonate.

### DESCRIPTION OF VARIOUS EMBODIMENTS

According to a method of the present invention, electrochemical detection of an analyte takes place in the presence of a species which is capable of forming an intercalation compound with a carbon host material. Intercalation compounds are generally formed by a reaction (usually reversible) which involves introduction of a guest species into a host structure without major structural modification of the host. Methods for forming and determining the composition of intercalation compounds are well known in the art. In general, the species will be capable of forming an intercalation compound with a host material comprising a form of carbon other than a MWCNT. Typically, the species will be capable of forming an intercalation compound with a graphite or graphitic material, for example edge plane or basal plane pyrolytic graphite. One or more (e.g. all) of the analyte, the electrolyte and a solvent may comprise a species capable of undergoing intercalation. One or more intercalating species may be present. The species may be capable of forming the intercalation compound in the conditions (e.g. temperature or potential) under which detection takes place.

Detection may take place in the presence of a non-aqueous liquid, e.g. an organic solvent, which is capable of forming an intercalation compound with carbon. Thus, the sample and/or an electrolyte may be dissolved in such a solvent. Examples of organic solvents which are capable of intercalating carbon include 1,2 dimethoxyethane (DME), dimethylsulfoxide (DMSO), propylene carbonate (PC), ethylene carbonate (EC), 1,2-diethoxyethane (DEE), dimethoxymethane (DMM), diethoxymethane (DEM) and mixtures thereof. In this regard, reference is made to Besenhard, Carbon, 111, 14, 1976; and Abe, Synthetic Metals, 249, 125, 2002.

Alternatively or additionally, detection may take place in the presence of an ionic species which is capable of intercalating a carbon host. Examples of such ionic species include alkali metal ions (e.g. Li⁺, Na⁺ or K⁺), tetraalkylammonium cations (e.g. tetrabutylammonium), Cr⁵⁺, PF₆⁻, BF₄⁻, AsF₆⁻. SbF₆⁻ and ClO₄⁻. In this regard, reference is made to Kowronski, Karbo-Energochemia-Ekologia 56, 43, 1998; Santhanam, M. Journal of Power Sources 66, 47, 1997; Seel, Journal of the Electrochemical Society, 147, 892, 2000; Billaud, Journal of Power Sources 13, 1, 1984; Obert, Carbon 19, 3, 1981; and Santhanam, Journal of Power Sources 56, 101, 1995). An ionic species may be capable of co-intercalating a carbon host, for example with one of the non-aqueous solvents mentioned above.

The working electrode comprises a MWCNT. Various types of MWCNT are known in the art, examples including bamboo, hollow tube and herring bone MWCNTs. In a particular embodiment, the MWCNT is a bamboo MWCNT. MWCNTs typically have an outer diameter of between 5 and 100 nm, e.g between 5 and 50 nm. The length of a MWCNT is often between 1 to 50 μm, e.g. between 5 and 20 μm. The working electrode may comprise a substrate, e.g. a carbon substrate such as glassy carbon, comprising one or more MWCNTs. An exemplary substrate is glassy carbon, although other suitable substrates will be apparent to those skilled in the art. Methods for producing such electrodes are known in the art. For example, a working electrode for use in the invention may be manufactured by first dispersing an amount of MWCNTs in ethanol, placing the resulting suspension into an ultrasonic bath and then pipetting this composition onto a substrate, for example glassy carbon. Subsequent volatilization may then produce a presumed random distribution of the MWCNTs on the substrate surface.

An electrochemical sensor of the invention generally comprises working and counter electrodes and an electrolyte. Exemplary types of working electrode include describe above. The counter electrode may be any suitable electrode, for example a platinum or graphite electrode. Various electrochemical techniques, for example cyclic voltammetry and amperometry, are encompassed by the present invention. Accordingly, the invention may further involve the use of a reference electrode. The reference electrode may be, for example, a saturated calomel electrode (SCE), a graphite electrode or a silver electrode.

A potential may be applied across the electrodes using a potentiostat, and the response of the cell to the sample determined. For determination of the voltammetric response, the applied potential is varied relative to a reference electrode; in this way, a cyclic voltammogram may be obtained. Alternatively, the amperometric response of the cell can be determined by applying a fixed potential across the electrodes, optionally controlled relative to a reference electrode.

The following Example illustrates the invention.

### Example

### Electrochemical Detection of Ammonia

### Materials and Methods

Propylene carbonate (Aldrich, 99.7%) and tetra-n-butylammonium perchlorate (TBAP, Fluka) were purchased at the highest grade available and used directly without further purification. Pure ammonia and nitrogen gas (BOC) were used for electrochemical experiments as described below. All the solutions were vigorously degassed with oxygen-free nitrogen until oxygen was no longer electrochemically detectable. All experiments were carried out at a temperature of 295±3 K.

Electrochemical experiments were performed using a μ-Autolab type II potentiostat (Eco-Chemie) controlled by General Purpose Electrochemical Systems v.4.7 software. For all electrochemical experiments carried out in the electrolyte, the working electrodes used were GC, BPPG (Le Carbone Ltd.), and EPPG (Le Carbone Ltd.). For BPPG and EPPG electrodes, discs of pyrolytic graphite were machined into a 4.9 mm diameter, with the disc face parallel with the edge plane, or basal plane as required. The counter electrode was a bright platinum wire with a large surface area, with a silver wire quasi-reference electrode completing the circuit. The GC electrode was polished using diamond lapping compounds (Kemet), while the EPPG was polished on alumina lapping compound of decreasing sizes (0.1-5 μm) on soft lapping pads. The BPPG electrode was prepared by first polishing the BPPG electrode surface on carborundum paper and then pressing cellotape on the cleaned BBPG surface before removing along with general attached graphite layers. Prior to use, the electrode was cleaned in acetone to remove any adhesive.

Bamboo MWCNTs (>95% purity, 10-20 nM diameter, 5-20 μm length) were obtained from NanoLab and used as received. The MWCNTs were cast onto a glassy carbon surface by first dispersing 2 mg of MWCNTs into 2 mL ethanol. The suspension was then placed into an ultrasonic bath for 1 minute, after which 20 μL was pipetted onto the electrode surface. This was then allowed to volatize at room temperature, producing a presumed random distribution of carbon nanotubes on the GC surface.

The electrochemical cell was a septum sealed three-necked flask. The cell was always held under a nitrogen atmosphere, to ensure that a fixed amount of ammonia was maintained throughout the experiments. In experiments where ammonia was utilised, the gas was directly introduced from a cylinder containing volume percentages (10 vol %; BOC Gases) by bubbling the ammonia directly into the solution (nitrogen comprised the remaining part of all the gas mixtures).

High resolution transmission electron microscopy was performed with a JEOL 4000EX operating at 400 kV, samples were dispersed in ethanol and loaded onto copper grids coated with Formvar. X-ray diffraction was performed using a Philips PANalytical X'pert pro diffractometer with Cu_{Kα} radiation, ë=1.5406 nm, 40 kV, 40 mA.

### Detection of Ammonia Using GC, EPPG and BPPG Electrodes

The electrochemical oxidation of ammonia was first investigated by bubbling 10% ammonia gas into 25 mL propylene carbonate (PC) containing 0.1 M tetra-n-butylammonium perchlorate (TBAP) for a period of 45 seconds. GC, EPPG and BPPG electrodes were in turn used with the voltammetric responses explored via cyclic voltammetry.

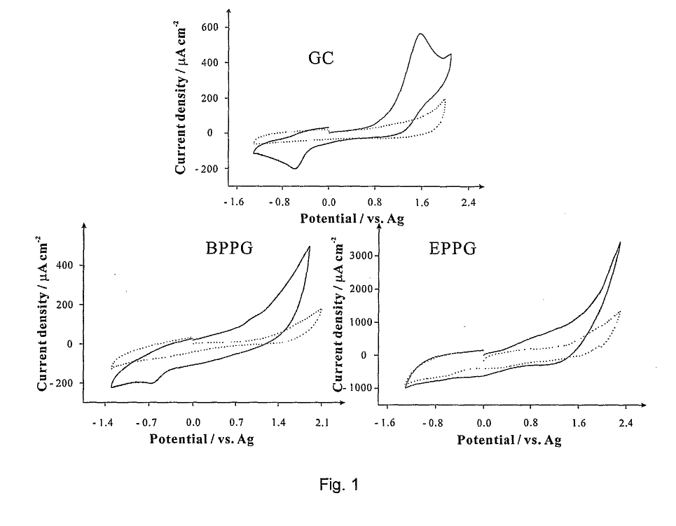

The observed cyclic voltammograms are depicted in FIG. 1, where a large oxidation wave with a peak potential at ca. +1.6 V (vs. Ag wire) is seen at the glassy carbon electrode. The electrochemical oxidation of ammonia is believed to proceed via the following electrochemical step:

4NH₃(g)−3e⁻→3NH₄⁺+½N₂(g) (1)

On the reverse (reductive seen) a CE process takes place in which a proton formed via dissociation of NH₄⁺ is electrochemically reduced to produce hydrogen (at the GC electrode this is seen at ca. −0.65 V vs. Ag wire):

C: NH₄⁺ [symbol] NH₃(g)+H⁺ (2)

E: H⁺+e⁻→½H₂(g) (3)

The electrochemical oxidation of ammonia at the EPPG and BPPG electrodes was then explored. As FIG. 1 shows, the voltammetric responses show no significant oxidation waves corresponding to the electrochemical oxidation of ammonia. It has previously been shown that for redox couples in aqueous solution, EPPG electrodes often exhibit considerably faster electrode kinetics in comparison with BPPG or GC electrodes. Since the heterogeneous charge transfer probably occurs almost exclusively at the edge plane sites, the electrochemical reversibility is greatly enhanced as the number of edge plane sites per unit area is increased. However, in the present case it appears that increasing the proportion of edge plane sites does not improve electrochemical reversibility. Indeed, no analytically useful voltammetric response is seen at the EPPG electrode. Also, the magnitude of the current scale at the EPPG electrode was ca. 6-7 times larger than that of the BPPG electrode.

The accessible potential windows were then explored in a propylene carbonate solution containing 0.1 M TBAP. The potential window is defined as the range of potentials between which the current is less than +/−1.6 mA cm⁻² in the anodic and cathodic directions. Comparison of the accessible potential windows revealed that the GC electrode had a window of 5.9 V, while the EPPG and BPPG electrodes had potential windows of 2.9 V and 3.7 V respectively. Anodic limits in propylene carbonate extend up to ca. +2.7 V (vs. Ag wire) for GC before the onset of solvent breakdown, while the BPPG and the EPPG electrodes have anodic limits of ca. +1.9 V and +1.6 V (vs. Ag wire) respectively. It may be inferred that, given the shorter anodic limits of the BPPG and the EPPG electrodes compared with the GC electrode, the oxidation of ammonia may occur in the region of solvent decomposition, making it seem voltametrically “invisible”.

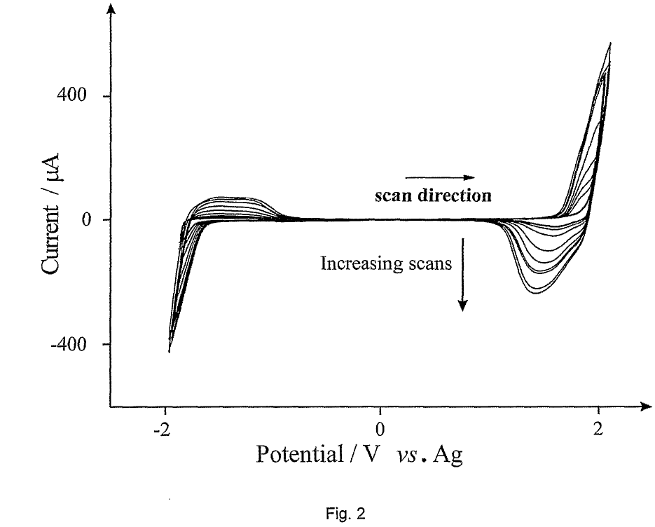

FIG. 2 shows consecutive voltammetric scans recorded at a BPPG electrode in propylene carbonate containing 0.1 M TBAP. In the process of scanning, the potential window is steadily reduced and the intercalation of both TBA⁺ and ClO₄⁻ plus solvent is believed to occur at the edge plane-like defects.

It is believed that propylene carbonate and the supporting electrolyte are intercalated into the graphite planes at potentials near the limits of the potential sweeps. This causes exfoliation of the graphite layers and irreversibly damages the electrode. This accounts for the absence of any voltammetry corresponding to ammonia in propylene carbonate observed at the EPPG and BPPG electrodes within the accessible potential window.

### Detection of Ammonia Using a MWCNT Electrode

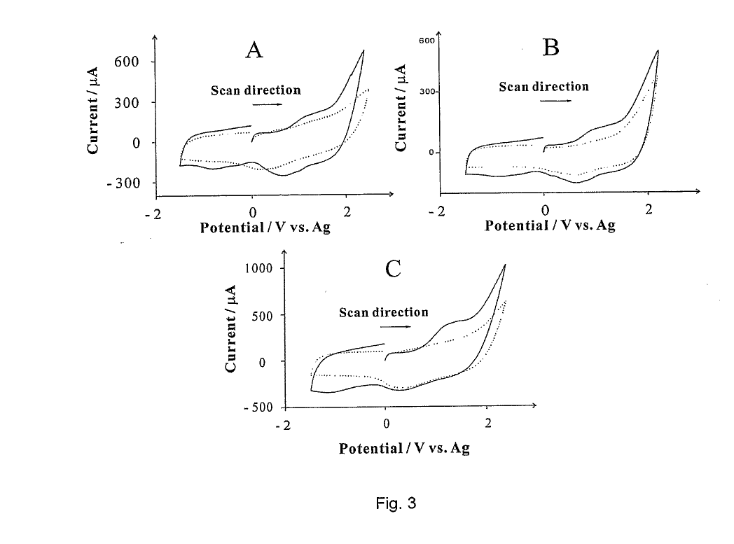

MWCNTs were immobilised onto a GC electrode and placed into 25 mL propylene carbonate containing 0.1 M TBAP. 10% ammonia gas was bubbled through the latter for 45 seconds. The electrochemical oxidation of ammonia was then explored. As shown in FIG. 3A, a voltammetric peak is observed at ca. +1.15 V (vs. Ag wire).

Samples of the MWCNTs were then left in the propylene carbonate solution for 24 hours and 7 days. After the various time periods of exposure of the nanotubes to propylene carbonate had elapsed, the MWCNTs were washed with ethanol and filtered under vacuum. The MWCNTs samples were then dispersed onto the glassy carbon according to the procedure described above. FIGS. 3B and 3C depict the response in the propylene carbonate solution containing ammonia. The voltammetric responses for the MWCNTs left in propylene carbonate for 24 hours (FIG. 3B) and 7 days (FIG. 3C) are indistinguishable from that shown in FIG. 3A.

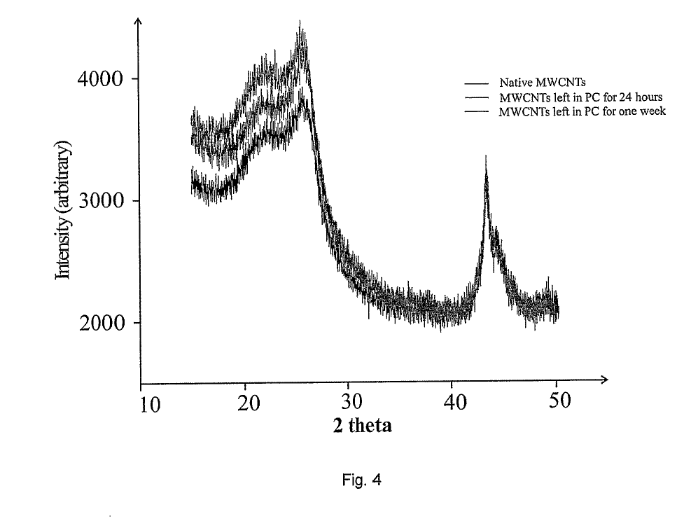

X-ray diffraction (XRD) was conducted on the MWCNTs which had been exposed to propylene carbonate for 24 hrs and 7 days, and compared to the spectra of the nanotube before any exposure to propylene carbonate. FIG. 4 shows the XRD spectra. The peak at ca. 25° is attributable to graphite (002), while the waves before this peak are attributable to amorphous scatter (Mehta, Carbon 2003, 41, 2159). Peaks at ca. 42° due to (100) and (101) are evident; these are identical to that observed previously for MWCNTs and are attributable to the honeycomb lattice of single grapheme sheets (Belin et al, Mat. Sci. Eng. B 2005, 119, 105). Comparison of the spectra obtained from the exposed MWCNTs reveals no difference between the exposed nanotubes and native nanotubes, indicating that no change in the interlayer spacing has occurred. Transmission electron microscopy (TEM) was performed on the MWCNTs before and after exposure to propylene carbonate, and no distinct change in the interlayer spacing could be observed. These results suggest that intercalation of the MWCNT did not occur.

Without wishing to be bound by theory, it is believed that the unique and relatively rigid structure of MWCNTs is such that propylene carbonate solvent molecules are unable to penetrate between the graphite layers. As a result, exfoliation of the carbon layers is inhibited and the voltammetric response corresponding to the oxidation of ammonia is unperturbed by any competing intercalation or exfoliation processes.

1. A method of detecting an analyte in a sample, which comprises the steps of contacting the sample with a working electrode in the presence of an electrolyte and determining the electrochemical response of the working electrode to the sample, wherein the working electrode comprises a multi-walled carbon nanotube (MWCNT) and wherein detection takes place in the presence of a species which is capable of forming an intercalation compound with a carbon host material.

2. A method according to claim 1, wherein the species is capable of forming an intercalation compound with a graphite or graphitic host material.

3. A method according to claim 1, wherein the sample comprises a species which is capable of forming an intercalation compound with a carbon host material.

4. A method according to claim 3, wherein the analyte comprises a species which is capable of forming an intercalation compound with a carbon host material.

5. A method according to claim 1, wherein the electrolyte comprises a species which is capable of forming an intercalation compound with a carbon host material.

6. A method according to claim 1, wherein detection takes place in the presence of an organic solvent comprising a species which is capable of forming an intercalation compound with a carbon host material.

7. A method according to claim 6, wherein the organic solvent is 1,2 dimethoxyethane (DME), dimethylsulfoxide (DMSO), propylene carbonate (PC), ethylene carbonate (EC), 1,2-diethoxyethane (DEE), dimethoxymethane (DMM), diethoxymethane (DEM) or a mixture thereof.

8. A method according to claim 7, wherein the organic solvent comprises propylene carbonate.

9. A method according to claim 1, wherein detection takes place in the presence of an ionic species which is capable of forming an intercalation compound with a carbon host material.

10. A method according to claim 9, wherein the ionic species is selected from alkali metal ions (e.g. Li⁺, Na⁺ or K⁺), tetraalkylammonium cations (e.g. tetrabutylammonium), Cr⁵⁺, PF₆⁻, BF₄⁻, AsF₆⁻, SbF₆⁻ and ClO₄⁻.

11. A method according to claim 9, wherein detection takes place in the presence of tetra-n-butylammonium perchlorate.

12. A method according to claim 1, wherein the MWCNT comprises a bamboo MWCNT.

13. A method according to claim 1, wherein the analyte is ammonia.

14. An electrochemical sensor for the detection of an analyte in a sample, which comprises working and counter electrodes and an electrolyte, wherein the working electrode comprises a multi-walled carbon nanotube (MWCNT) and wherein the sensor comprises a species which is capable of forming an intercalation compound with a carbon host material.

15. A sensor according to claim 14, wherein the species is capable of forming an intercalation compound with a graphite or graphitic host material.

16. A sensor according to claim 14, wherein the electrolyte comprises a species which is capable of forming an intercalation compound with a carbon host material.

17. A sensor according to claim 14, wherein the sensor comprises an organic solvent comprising the species.

18. A sensor according to claim 17, wherein the organic solvent is 1,2 dimethoxyethane (DME), dimethylsulfoxide (DMSO), propylene carbonate (PC), ethylene carbonate (EC), 1,2-diethoxyethane (DEE), dimethoxymethane (DMM), diethoxymethane (DEM) or a mixture thereof.

19. A sensor according to claim 18, wherein the solvent comprises propylene carbonate.

20. A sensor according to claim 14, wherein the sensor comprises an ionic species which is capable of forming an intercalation compound with a carbon host material.

21. A sensor according to claim 20, wherein the ionic species is selected from alkali metal ions (e.g. Li⁺, Na⁺ or K⁺), tetraalkylammonium cations (e.g. tetrabutylammonium), Cr⁵⁺, PF₆⁻, BF₄⁻, AsF₆⁻. SbF₆⁻ and ClO₄⁻.

22. A sensor according to claim 20, wherein the sensor comprises tetra-n-butylammonium perchlorate.

23. A sensor according to claim 14, wherein the MWCNT comprises a bamboo MWCNT.

24. Use of an electrode material for the electrochemical detection of an analyte in a sample, wherein the material comprises a multi-walled carbon nanotube (MWCNT) and wherein detection takes place in the presence of a species which is capable of forming an intercalation compound with a carbon host material.

25. A composition comprising a multi-walled carbon nanotube (MWCNT) and a species which is capable of forming an intercalation compound with a carbon host material.
